(19) United States
(12) Patent Application Publication
(10) Pub. No.: US 2025/0035277 A1
(43) Pub. Date: Jan. 30, 2025

(54) DUAL DRIVE WATER LAMP STRUCTURE

(71) Applicant: HUIZHOU DICHENG ELECTRONIC TECHNOLOGY CO., LTD, Huizhou City (CN)

(72) Inventor: BINJIE PAN, Huizhou City (CN)

(21) Appl. No.: 18/358,955

(22) Filed: Jul. 26, 2023

(51) Int. Cl. F21S 10/00; F21V 3/02

(52) U.S. Cl. CPC F21S 10/002; F21V 3/02; F21W 2121/00

(57) ABSTRACT

Provided is a dual drive water lamp structure, including a base, a water lamp body, a rotating assembly, and a water stirring assembly. An electronic control unit is disposed in the base. The water lamp body is disposed on the base. The rotating assembly includes a first driving member and a rotating member. The rotating member is connected to the first driving member, and the first driving member drives the rotating member to rotate. The water stirring assembly includes a second driving member and a magnetic stirring member. The second driving member is disposed on the base and includes a magnetic rotating shaft, and the magnetic stirring member is disposed in the water lamp body and rotated by magnetic suction of the magnetic rotating shaft.

### BACKGROUND

### Technical Field

The present invention relates to the technical field of handicrafts, and in particular, to a dual drive water lamp structure.

### Related Art

Generally, decorations that are often placed on desks in daily life are photo frames, toy accessories, etc., and the decorations all have static functions that are beautiful and ornamental. Therefore, there are some water lamp designs with sparkles, glitters, or decorations inside in the market, and the sparkles, glitters, or decorations inside are made to produce a liquid flowing visual feeling by manually shaking upside down or by electricity, so that the water lamp has an expandable space, and can extend to a variety of visual changes or multi-functional and interesting development. However, this type of water lamp design is to present an internal dynamic effect.

In view of this, based on years of experience in researching accessories such as decorations, the creator came up with a design that can not only be for decorations, but also present an internal dynamic effect and an external dynamic effect at the same time, and is further added with ornaments, aesthetics, and interestingness. Through continuous testing and improvement, this creation is generated.

### SUMMARY

An objective of the present invention is to provide a more beautiful and more interesting dual drive water lamp structure.

In order to resolve the above technical problem, the present invention can be implemented by adopting the following technical solutions:

A dual drive water lamp structure is provided and comprises:
a base, where an electronic control unit is disposed in the base;
a water lamp body, disposed on the base, where the water lamp body is in a hollow and transmissive three-dimensional shape, and is sealed with a liquid inside;
a rotating assembly, comprising a first driving member and a rotating member, where the first driving member is electrically connected to the electronic control unit, the rotating member is connected to the first driving member, and the first driving member drives the rotating member to rotate; and
a water stirring assembly, comprising a second driving member and a magnetic stirring member, where the second driving member is disposed on the base and electrically connected to the electronic control unit, the second driving member comprises a magnetic rotating shaft, and the magnetic stirring member is disposed in the water lamp body and rotated by magnetic suction of the magnetic rotating shaft, to stir the liquid in the water lamp body.

In an embodiment, the first driving member is located at the top of the water lamp body, an output end of the first driving member is connected to the rotating member, and the rotating member is disposed at the top of the water lamp body or disposed around the outside of the water lamp body.

In an embodiment, the rotating assembly further comprises a cover body, the cover body covers the first driving member, and the cover body comprises a through hole for the rotating member to connect to the output end of the first driving member.

In an embodiment, the first driving member is disposed on the base, an output end of the first driving member is connected to a main gear, the rotating member is sleeved on the water lamp body and comprises an internal gear engaged with the main gear, and the first driving member drives the main gear to rotate, to drive the rotating member to rotate.

In an embodiment, the rotating member is decorated with ornaments.

In an embodiment, the water lamp body comprises a housing and a seal cover, the seal cover seals and covers the bottom of the housing, and the seal cover is connected to a fixed support for limiting the magnetic stirring member.

In an embodiment, the dual drive water lamp structure further comprises a light-emitting unit, where the light-emitting unit is electrically connected to the electronic control unit to illuminate the water lamp body.

In an embodiment, the electronic control unit comprises a transfer switch for controlling the start or stop of the first driving member or/and the second driving member.

In an embodiment, a power supply of the electronic control unit is an external power supply or an internal battery.

In an embodiment, the first driving member and the second driving member are both motors.

### The Beneficial Effects are:

In the dual drive water lamp structure of the present invention, the first driving member in the rotating assembly drives the rotating member to rotate, and the rotating member is located outside the water lamp body, so that the water lamp structure can present an external rotating effect. At the same time, the second driving member in the water stirring assembly drives the magnetic stirring member inside the water lamp body to rotate, to stir the liquid inside the water lamp body to present an internal rotating effect. Finally, the dual drive is implemented through the first driving member and the second driving member, so that the water lamp structure can present an internal dynamic effect and an external dynamic effect at the same time, and the water lamp structure is more beautiful and more interesting.

### BRIEF DESCRIPTION OF THE DRAWINGS

FIG. 1 is a schematic structural diagram 1 of a dual drive water lamp structure according to the present invention;

FIG. 2 is a schematic structural diagram 2 of the dual drive water lamp structure according to the present invention;

FIG. 3 is a schematic exploded view of a water lamp body of the dual drive water lamp structure according to the present invention;

FIG. 4 is a schematic structural diagram of another embodiment of the dual drive water lamp structure according to the present invention;

FIG. 5 is a schematic structural diagram of a rotating assembly in another embodiment of the dual drive water lamp structure according to the present invention.

As Shown in the Accompanying Drawings:
100, base;
200, electronic control unit;
300, water lamp body; 310, housing; 320, seal cover; 330, fixed support;
400, rotating assembly; 410, first driving member; 411, main gear; 420, rotating member=; 421, internal gear; 430, cover body;
500, water stirring assembly; 510, second driving member; 520, magnetic stirring members; 530, magnetic rotating shaft;
600, ornaments;
700, light-emitting unit.

### DETAILED DESCRIPTION

In order to make the above objective, features, and advantages of the present invention more obvious and understandable, the specific embodiments of the present invention are described in detail below with reference to the accompanying drawings. Many specific details are described in the following description to facilitate a full understanding of the present invention. However, the present invention can be implemented in many different ways from those described herein, and a person skilled in the art can make similar improvements without violating the connotation of the present invention. Therefore, the present invention is not limited by the specific embodiments disclosed below.

It should be noted that, when a component is expressed as being “fixed to” another component, the component may be directly on the another component or there may be an intermediate component. When a component is expressed as being “connected to” another component, the component may be directly connected to the another component or there may be an intermediate component. Conversely, when a component is expressed as being “directly on” another component, there is no intermediate component. The terms “vertical”, “horizontal”, “left”, “right”, and similar expressions used herein are merely for illustrative purposes.

Unless otherwise defined, all technical and scientific terms used herein have the same meaning as commonly understood by a person skilled in the art of the present invention. The terms used herein in this specification of the present invention are merely for the purpose of describing specific embodiments and not intended to limit the present invention. The term “and/or” used herein includes any and all combinations of one or more related listed items.

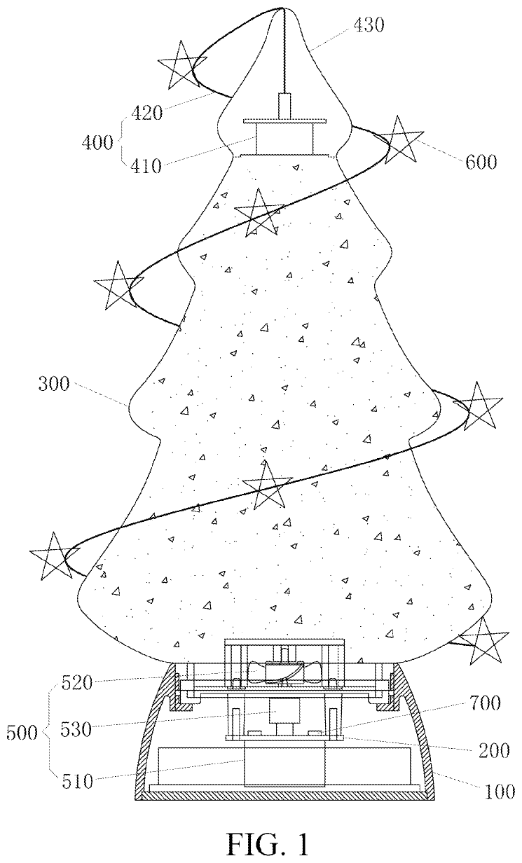

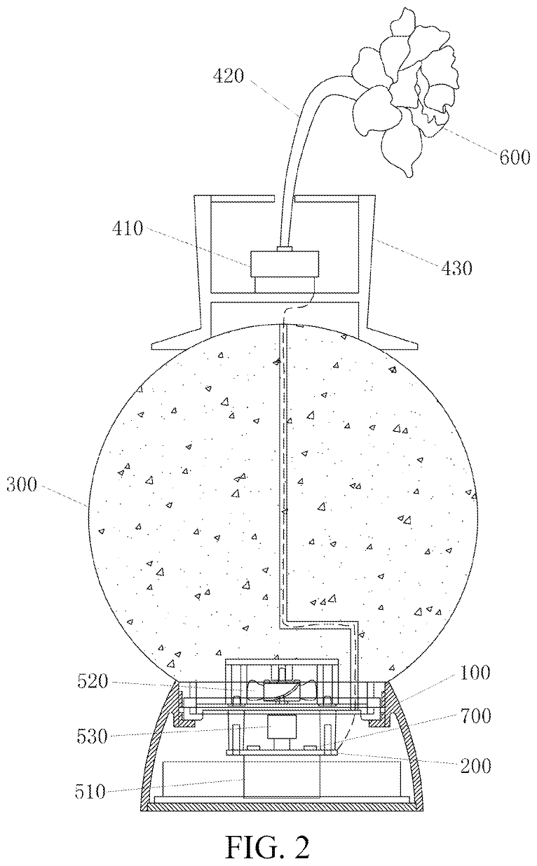

Referring to FIG. 1 and FIG. 2, a dual drive water lamp structure includes:
a base 100, where an electronic control unit 200 is disposed in the base 100;
a water lamp body 300, disposed on the base 100, where the water lamp body 300 is in a hollow, and transmissive three-dimensional shape, and is sealed with a liquid inside;
a rotating assembly 400, including a first driving member 410 and a rotating member 420, where the first driving member 410 is electrically connected to the electronic control unit 200, the rotating member 420 is connected to the first driving member 410, and the first driving member 410 drives the rotating member 420 to rotate; and
a water stirring assembly 500, including a second driving member 510 and a magnetic stirring member 520, where the second driving member 510 is disposed on the base 100 and electrically connected to the electronic control unit 200 the second driving member 510 includes a magnetic rotating shaft 530, and the magnetic stirring member 520 is disposed in the water lamp body 300 and rotated by magnetic suction of the magnetic rotating shaft 530, to stir the liquid in the water lamp body 300. In addition, the water stirring assembly includes a reduction gear mechanism that allows the water stirring speed to achieve normal and slow stirring effects.

Specifically, in this embodiment, the electronic control unit 200 is disposed inside the base 100, and a power supply of the electronic control unit 200 is an external power supply or an internal battery. The water lamp body 300 sealed with the liquid is mounted on the base 100, and the first driving member 410 of the rotating assembly 400 is disposed at the top of the water lamp body 300. Because the first driving member 410 needs to be electrically connected to the electronic control unit 200, an external wiring manner can be adopted or an internal wiring can be adopted during electrical connection. When the internal wiring manner is adopted, a hollow channel penetrating the top and bottom can be formed inside the water lamp body 300, and the wire can be routed from the hollow channel, thereby improving electrical safety.

The rotating member 420 in the rotating assembly 400 is connected to an output end of the first driving member 410, and the rotating member 420 may be located at the top of the water lamp body 300 or around the outside of the water lamp body 300. When the first driving member 410 is started, the rotating member 420 is driven to rotate, so that the water lamp structure presents an external rotating effect.

In addition, the second driving member 510 in the water stirring assembly 500 is disposed in the base 100, and the magnetic stirring member 520 in the water stirring assembly 500 is disposed inside the water lamp body 300. The second driving member 510 includes a magnetic rotating shaft 530. When the second driving member 510 is started, the magnetic rotating shaft 530 is driven to rotate. Through magnetic suction principle, the magnetic rotating shaft 530 drives the magnetic stirring member 520 inside the water lamp body 300 to rotate, and when rotating, the magnetic stirring member 520 stirs the liquid inside the water lamp body 300 to flow, so that the water lamp structure presents an internal rotating effect.

Finally, the dual drive is implemented through the first driving member 410 and second driving member 510, and the first driving member 410 and the second driving member 510 are both motors, so that the water lamp structure can present an internal dynamic effect and an external dynamic effect at the same time, and the water lamp structure is more beautiful and more interesting.

When the first driving member 410 is disposed at the top of the water lamp body 300, a bonding manner can be directly adopted. In order to protect the first driving member 410 and improve the overall aesthetics of the water lamp structure, the rotating assembly 400 further includes a cover body 430. The cover body 430 directly covers the first driving member 410, and after the cover body 430 covers the first driving member 410, the cover body 430 can match with the water lamp body 300, so that the water lamp body 300 can be formed into various shapes. The first driving member 410 can be mounted on the cover body 430. Certainly, in order to facilitate the connection of the rotating member 420 to the output end of the first driving member 410, the cover body 430 further includes a through hole. The through hole is used to connect the rotating member 420 to the first driving member 410, so that the first driving member 410 can normally drive the rotating member 420 to rotate.

In order to better improve the aesthetics and interestingness of the water lamp structure, various ornaments 600 can also be disposed on the rotating member 420, and a plurality of ornaments 600 can be disposed. When the rotating member 420 rotates, the ornaments 600 disposed on the rotating member 420 are driven to rotate, thereby improving the aesthetics and interestingness of the water lamp structure.

In addition, the dual drive water lamp structure further includes a light-emitting unit 700. The light-emitting unit is an SMD LED lamp. The light-emitting unit 700 is electrically connected to the electronic control unit 200, and the light-emitting unit 700 can be directly disposed in the base 100 to illuminate the water lamp body 300 from the bottom up, or the light-emitting unit 700 can be disposed at the top of the water lamp body 300 to illuminate the water lamp body 300 from the top down. Through the illumination of the light-emitting unit 700, the light is refracted by the liquid inside the water lamp body 300, so that the illuminated light is more dazzling. In combination with the internal dynamic effect and the external dynamic effect, the water lamp structure is more beautiful and more interesting.

Certainly, in order to better control the internal dynamic effect and the external dynamic effect, the electronic control unit 200 includes a transfer switch for controlling the start or stop of the first driving member 410 or/and the second driving member 510. The transfer switch can control the simultaneous start/stop of the first driving member 410 and the second driving member 510, or can control the start of the first driving member 410 and the stop of the second driving member 510, or can control the stop of the first driving member 410 and the start of the second driving member 510, so that the water lamp structure is more diversified in use and presents different rotation modes, thereby making the water lamp structure more interesting.

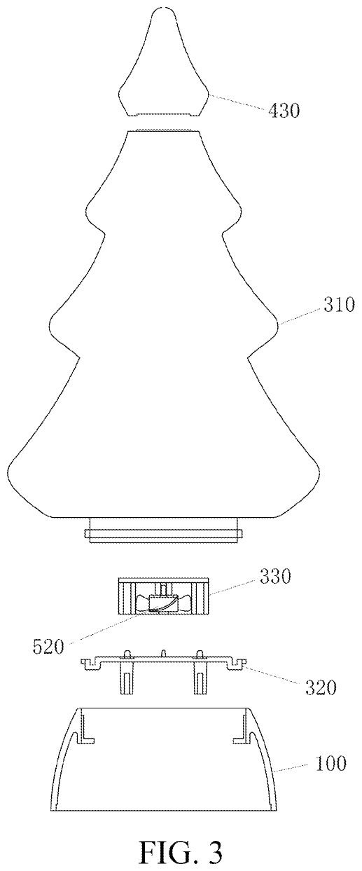

Referring to FIG. 3, because the water lamp body 300 in this embodiment needs to be sealed, the water lamp body 300 includes a housing 310 and a seal cover 320. After the liquid is injected into the housing 310, the seal cover 320 seals and covers the bottom of the housing 310. In order to mount and fix the magnetic stirring member 520 inside the water lamp body 300, the seal cover 320 is connected to a fixed support 330, and the magnetic stirring member 520 is located between the fixed support 330 and the seal cover 320. The magnetic stirring member 520 is limited by the fixed support 330, thereby improving the stability of the magnetic stirring member 520 when rotating.

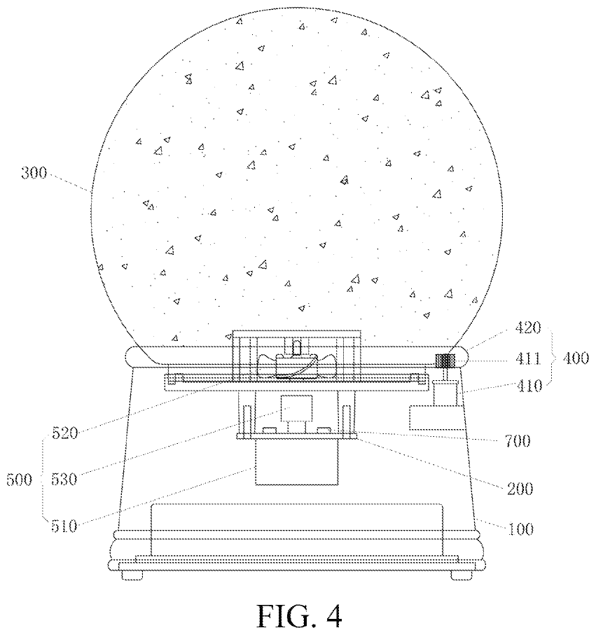

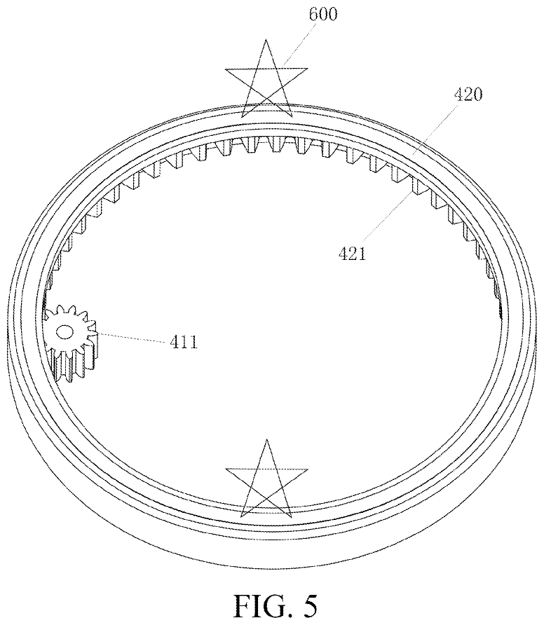

Referring to FIG. 4 and FIG. 5, in another embodiment, the first driving member 410 in the rotating assembly 400 may also be disposed in the base 100 and connected to a main gear 411 at the output end of the first driving member 410. The rotating member 420 is sleeved on the water lamp body 300 and includes an internal gear 421 engaged with the main gear 411, and the first driving member 410 drives the main gear 411 to rotate to drive the rotating member 420 to rotate.

When the first driving member 410 is started, the first driving member 410 drives the main gear 411 to rotate. Because the main gear 411 and the internal gear 421 of the rotating member 420 are engaged with each other, the rotating member 420 is driven to rotate around the water lamp body 300 to form an external rotating effect. Similarly, several ornaments 600 can be disposed on the rotating member 420. In combination with the liquid flow inside the water lamp body 300 stirred by the water stirring assembly 500 and the illumination of the light-emitting unit 700, finally, the water lamp structure can present an internal dynamic effect, an external dynamic effect, and a lighting effect at the same time, thereby making the water lamp structure more beautiful and more interesting.

The above shows and describes the basic principles and main features of the present invention and the advantages of the present invention. Any person skilled in the art can smoothly implement the present invention as shown in the accompanying drawings and as described above. However, equivalent changes of alterations, modifications and evolutions made by any person skilled in the art using the above-disclosed technical content without departing from the scope of the technical solutions of the present invention are equivalent embodiments of the present invention. In addition, any alteration, modification and evolution of any equivalent change made to the above embodiments according to the technical essence of the present invention still fall within the protection scope of the technical solutions of the present invention.

What is claimed is:

1. A dual drive water lamp structure, comprising:
a base, wherein an electronic control unit is disposed in the base;
a water lamp body, disposed on the base, wherein the water lamp body is in a hollow and transmissive three-dimensional shape, and is sealed with a liquid inside;
a rotating assembly, comprising a first driving member and a rotating member, wherein the first driving member is electrically connected to the electronic control unit, the rotating member is connected to the first driving member, and the first driving member drives the rotating member to rotate; and
a water stirring assembly, comprising a second driving member and a magnetic stirring member, wherein the second driving member is disposed on the base and electrically connected to the electronic control unit, the second driving member comprises a magnetic rotating shaft, and the magnetic stirring member is disposed in the water lamp body and rotated by magnetic suction of the magnetic rotating shaft, to stir the liquid in the water lamp body.

2. The dual drive water lamp structure according to claim 1, wherein: the first driving member is located at the top of the water lamp body, an output end of the first driving member is connected to the rotating member, and the rotating member is disposed at the top of the water lamp body or disposed around the outside of the water lamp body.

3. The dual drive water lamp structure according to claim 2, wherein: the rotating assembly further comprises a cover body, the cover body covers the first driving member, and the cover body comprises a through hole for the rotating member to connect to the output end of the first driving member.

4. The dual drive water lamp structure according to claim 1, wherein: the first driving member is disposed on the base, an output end of the first driving member is connected to a main gear, the rotating member is sleeved on the water lamp body and comprises an internal gear engaged with the main gear, and the first driving member drives the main gear to rotate, to drive the rotating member to rotate.

5. The dual drive water lamp structure according to claim 1, wherein: the rotating member is decorated with ornaments.

6. The dual drive water lamp structure according to claim 2, wherein: the rotating member is decorated with ornaments.

7. The dual drive water lamp structure according to claim 3, wherein: the rotating member is decorated with ornaments.

8. The dual drive water lamp structure according to claim 4, wherein: the rotating member is decorated with ornaments.

9. The dual drive water lamp structure according to claim 1, wherein: the water lamp body comprises a housing and a seal cover, the seal cover seals and covers the bottom of the housing, and the seal cover is connected to a fixed support for limiting the magnetic stirring member.

10. The dual drive water lamp structure according to claim 1, further comprising a light-emitting unit, wherein the light-emitting unit is electrically connected to the electronic control unit to illuminate the water lamp body.

11. The dual drive water lamp structure according to claim 1, wherein: the electronic control unit comprises a transfer switch for controlling the start or stop of the first driving member or/and the second driving member.

12. The dual drive water lamp structure according to claim 1, wherein: a power supply of the electronic control unit is an external power supply or an internal battery.

13. The dual drive water lamp structure according to claim 1, wherein: the first driving member and the second driving member are both motors.
